(19) United States
(12) Patent Application Publication
(10) Pub. No.: US 2014/0134969 A1
(43) Pub. Date: May 15, 2014

(54) TERMINAL AND METHOD FOR TRANSMITTING AN EMERGENCY MESSAGE

(71) Applicant: Samsung Electronics Co., Ltd., Gyeonggi-do (KR)

(72) Inventors: Youngtae JIN, Gyeonggi-do (KR); Kyungjung KIM, Gyeonggi-do (KR)

(73) Assignee: Samsung Electronics Co., Ltd., Gyeonggi-do (KR)

(21) Appl. No.: 14/074,898

(22) Filed: Nov. 8, 2013

(30) Foreign Application Priority Data
Nov. 9, 2012 (KR) 10-2012-0126648

(51) Int. Cl. H04W 4/22

(52) U.S. Cl. CPC H04W 4/22
USPC 455/404.1

(57) ABSTRACT

An emergency message transmission apparatus and method is provided for reporting an emergency situation efficiently. An emergency message transmission method of a terminal includes detecting an emergency situation information collect request event; collecting emergency situation information in response to the emergency situation information collection request event; detecting an emergency message display request event; displaying collected emergency situation information sorted per type in response to the to emergency message display request event; detecting an emergency message transmission request event; and transmitting an emergency message including the emergency situation information to at least one recipient numbers in response to the emergency message transmission request event.

### CROSS RELATED APPLICATION

This application claims the benefit of priority under 35 U.S.C. §119(a) from a Korean patent application filed on Nov. 9, 2012 in the Korean Intellectual Property Office and assigned Serial No. 10-2012-0126648, the entire disclosure of which is hereby incorporated by reference.

### BACKGROUND

1. Technical Field

The present disclosure relates to emergency message transmission and, in particular, to an emergency message transmission apparatus and method for reporting an emergency situation efficiently.

2. Description of the Related Art

Typically, the recent portable terminal is equipped with a touch panel and a camera so as to process and store an image taken by the camera and receive a user input for controlling the operation of the terminal and entering data by means of the touch panel. More recently, the recent portable terminal tends to include text and speech recognition functions.

With the advance of communication technologies, mobile terminals such as smartphone and tablet PC have been popularized. Typically, most mobile terminals support an emergency or urgency call function. The user in emergency situation may try to place an emergency or urgency call to report the emergency situation to the local authorities (e.g., police, fire or EMS), pre-designated users, and/or emergency control center.

Recently, various natural disasters (such as unseasonal high or low temperature, earthquake, flooding, tornado, wild fire, and tsunami) are occurring frequently and unpredictably. Also, it is a recent tendency that violent crimes (such as human trafficking, abduction, and burglary) are on the rise. Accordingly, there is a need of a system for collecting, when encountering the emergency situation of natural disaster or criminal threat, the information on the emergency situation accurately and reporting the emergency situation promptly.

Sometimes, the emergency situations are handled and managed by a national or regional disaster management authority in such way of collecting the emergency situation information from local authorities and command the local authorities the appropriate actions to resolve the situation. Such an emergency situation management system operates in such a way that a communication service provider or a national disaster management authority collects the emergency situation information independently and alerts the public through, e.g., Short Message Service (SMS) or Cell Broadcasting Service (CBS). However, these systems are limited in collecting information on accurate emergency situation from plural mobile terminal users.

Although the unicast communication may guarantee the reliability of information transmission, it is difficult to expect accurate and prompt information delivery. In an exemplary case of the Cell Broadcasting Service used by the National Disaster Management System in some countries, the broadcast message includes a simple message such as ‘3 PM, intensity 5 earthquake at Gyeonggi. There is therefore a need of a method for delivering emergency situation information in detail and promptly.

### SUMMARY

The present invention has been made in an effort to solve the above problem and it is an object of the present invention to provide a mobile terminal and method that is capable of collecting situation information in a certain emergency situation (such as earthquake, tsunami, robbery, and violent assault) and transmitting an emergency message to the emergency situation management authority (e.g., emergency control center server) promptly.

In accordance with an embodiment of the present invention, an emergency message transmission method of a terminal includes detecting an emergency situation information collect request event by an input; collecting emergency situation information in response to the emergency situation information collection request event in a memory; detecting an emergency message display request event by an input unit; displaying collected emergency situation information on a display sorted by type in response to the emergency message display request event; detecting an emergency message transmission request event by an input unit; and transmitting an emergency message by a wireless communication unit including the emergency situation information to at least one recipient numbers in response to the emergency message transmission request event.

In accordance with another embodiment of the present invention, a terminal includes a touchscreen capable of detecting a user's request event related to emergency message and of displaying the emergency message with collected emergence situation information; a storage unit which stores a template of the emergency message; a wireless communication unit which transmits the emergency message; and a control unit which controls collecting emergency situation information corresponding to input fields of the template, displaying collected emergency situation information sorted by type, and transmitting an emergency message including the emergency situation information in response to the emergency message transmission request event.

In accordance with still another embodiment of the present invention, an emergency message information processing method of an emergency control center server includes receiving emergency messages structured in a template from plural terminals; performing data mining on the emergency messages; determining whether emergency situation information included in the emergency messages are reliable; processing, when the emergency situation information are reliable, the emergency situation information corresponding to respective information fields; aggregating emergency information processing results into a report; and transmitting the report to wireless devices within an area where the emergency situation has occurred and an emergency center.

### BRIEF DESCRIPTION OF THE DRAWINGS

FIG. 1 is a block diagram illustrating the configuration of a mobile terminal according to an embodiment of the present invention;

FIG. 2 is a flowchart illustrating the emergency message transmission method of the mobile terminal according to an embodiment of the present invention;

FIG. 3 is a flowchart illustrating the emergency message transmission method of the mobile terminal according to another embodiment of the present invention;

FIG. 4 is a diagram illustrating exemplary screens displayed in association with the emergency message transmission method according to an embodiment of the present invention;

FIG. 5 is a diagram illustrating exemplary screens displayed in association with the emergency message composition procedure of the method according to an embodiment of the present invention;

FIG. 6 is a diagram illustrating exemplary screens displayed in association with the execution of the camera in the method according to an embodiment of the present invention;

FIG. 7 is a diagram illustrating the architecture of the emergency information processing mechanism for the emergency message transmission method according to an embodiment of the present invention; and

FIG. 8 is a flowchart illustrating the server procedure for receiving the emergency text message and processing the emergency situation in the method according to an embodiment of the present invention.

### DETAILED DESCRIPTION

Exemplary embodiments of the present invention are described with reference to the accompanying drawings in detail. The terms and words used in this description and the appended claims are not to be interpreted in common or lexical meaning but, based on the principle that an inventor can adequately define the meanings of terms to best describe the invention, to be interpreted in the meaning and concept conforming to the technical concept of the present invention. Thus, it should be understood that there may be various equivalents and modified examples that can replace the embodiments described in the present specification and the configuration shown in the drawings at the time of filling the present application. In the drawings, certain elements may be exaggerated or omitted or schematically depicted for clarity of the invention, and the actual sizes of the elements are not reflected. Thus, the present invention is not limited in the relative sizes of the elements and distances therebetween.

In the following description, the term ‘emergency situation’ uses in the meaning including criminal situations such as burglary and natural disaster such as earthquake, tsunami, and forest fire.

In the following description, the term ‘emergency situation information’ denotes information collected to report the occurrence of the emergency situation. The emergency situation information may include, but is not limited to time information, location information, user identity information, and user input information. The time information may include date composed of year, month, and day, and even hour, minute, and second. The location information denotes the information on the location where the emergency situation has occurred. For example, the location information may include the GPS location coordinates or the address information acquired from the GPS location coordinates, or from any other source, e.g., a cellular network. The user identity information can denote the device identity information (e.g., phone number, IMEI, and ESN) of the mobile terminal used for reporting the emergency situation. The user input information may include any of text, video, still picture, and voice message recorded to inform of the detail of the emergency situation.

In the following description, the term ‘input field’ denotes a region to be filled with user input or system input in the emergency message template. The input fields can be classified into user input fields or automatic input fields. The input fields may also be classified into mandatory and optional input fields. The input fields may further include other fields, such as a recipient field, a time field, location field, a damage field, a file attach field, and a sender field.

The emergency message transmission apparatus and method according to an embodiment of the present invention is applicable to various types of mobile terminals. The mobile terminals include cellular phone, smartphone, tablet PC, hand-held PC, Portable Multimedia Player (PMP), Personal Digital Assistant (PDA), etc. In the following, the described embodiments are directed to the case where the emergency message transmission method and apparatus of the present invention is applied to a mobile terminal.

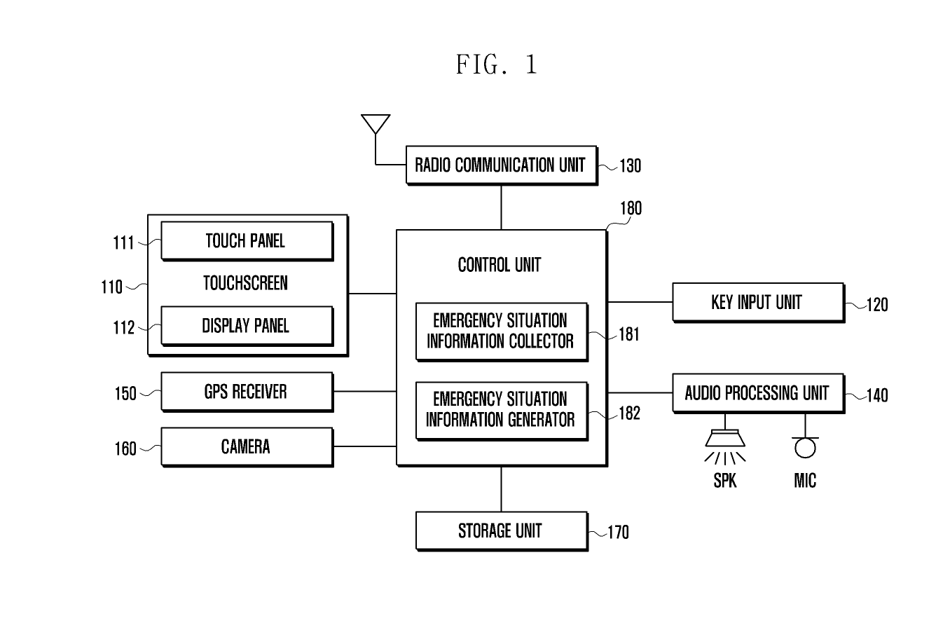

FIG. 1 is a block diagram illustrating the configuration of a mobile terminal according to an embodiment of the present invention.

As shown in FIG. 1, the mobile terminal 100 according to an embodiment of the present invention typically includes a touchscreen 110, a key input unit 120, a wireless communication unit 130, an audio processing unit 140, a camera 150, a GPS receiver 160, a storage unit 170, and a control unit 180, or any combination thereof.

The touchscreen 110 preferably includes a touch panel 111 and a display panel 112. The touchscreen 110 can generate an input signal corresponding to a user's gesture to the control unit 180. The control unit 180 can contain a processor and/or a microprocessor and detects the user's gesture based on the input signal and executes a function of the mobile terminal 100 according to the input signal. The user's gesture is most often classified into one of touch and touch gesture. The touch gesture generally includes tap, double tap, long tap, drag, drag & drop, flick, press, etc. The touch panel 111 can be implemented in add-on type formed on the surface of the display panel 112 or in on-cell type or in-cell type into the display panel. The touch panel 111 can be one of a resistive, capacitive, and electromagnetic induction type touch panel.

The display panel 112 preferably converts the video data received from the control unit 180 to an analog signal to display the screen under the control of the control unit 180. That is, the display panel 112 is capable of displaying various screens in accordance with the operations of the mobile terminal such as lock screen, home screen, application (hereinafter, referred to as “app execution screen”), menu screen, keypad screen, message composition screen, and Internet screen. In one embodiment of the present invention, the display panel 112 is capable of displaying an emergency message composition screen in response to a user request.

If one of the application icons displayed on the display panel 112 is selected by the user, the control unit 180 executes the corresponding application and controls the display panel 112 to display the execution screen of the application. The display panel 112 can be implemented with any display technology, such as Liquid Crystal Display (LCD), Organic Light Emitted Diode (OLED), and Active Matrix OLED (AMOLED).

The key input unit 120 is typically provided with a plurality of keys for receiving alphanumeric information and configuring various functions, but can also be integrated into the touchscreen 110. The function keys may include menu keys, screen on/off key, power on/off key, and volume control key, etc. The key input unit 120 is capable of generating key signals to the control unit 180 in association with user setting and function control of the mobile terminal 100. The key signals may include power on/off event, volume control event, screen on/off event, etc. The control unit 180 controls the components in response to these key events. The key input unit 120 may be implemented with one of qwerty keypad, 3*4 keypad, and 4*3 keypad composed of plural keys or even a custom arrangement of keys. In the case that the touch panel 111 of the mobile terminal 100 is implemented in the form of a full touchscreen, the key input unit 120 may include at least one side key for screen on/off and mobile terminal on/off.

The wireless communication unit 130 is responsible for establishing a communication channel with a wireless communication network for wireless communication of the mobile terminal under the control of the control unit 180. The wireless communication unit 130 is preferably capable of connecting to a specific server to receive time and location information. The wireless communication unit 130 may include in one example, a Radio Frequency (RF) transmitter for up-converting and amplifying signals to be transmitted and an RF receiver for low noise amplifying and down-converting the received signal. The wireless communication unit 140 is preferably capable of includes at least one of cellular communication module (including, but not limited to 3rd Generation (3G) cellular communication module, 3.5G cellular communication module, 4G cellular communication module, etc.) and digital broadcast module (e.g., DMB module). Other wireless protocols may also be used, including but not limited to WLAN, WiFi, WiBro, Wimax, 802.11, etc., just to name some non-limiting possibilities.

The audio processing unit 140 which may contain a subprocessor and/or separate processor, receives audio data output from the control unit 180, converts the audio data to an analog signal, and outputs the analog signal through the speaker (SPK). The audio processing unit 140 receives analog signal input through the microphone, converts the analog signal to audio data, and transfers the audio data to the control unit 180.

The GPS receiver 150 receives the GPS signals from GPS satellites and sends the GPS signals to the control unit 180 under the control of the control unit 180. That is, the GPS receiver 150 receives the satellite signals under the control of the control unit. The GPS receiver 150 typically sends the received GPS satellite signals to the control unit 180, where the control unit 180 calculates the location coordinates of the current location of the mobile terminal based on the GPS satellite signal and acquires the address information based on the location coordinates. The control unit 180 may receive the address information corresponding to the location coordinates from a specific server by means of the wireless communication unit 130. Although the present invention is described using the standard GPS system, as used herein, GPS can be any type of remote location determination system, including but not limited to GLONASS, OCX, the European Union Galileo positioning system, Chinese Compass navigation system, and Indian Regional Navigational Satellite System.

The camera 160 typically powers on and takes a still or motion picture to be sent to the control unit 180 in response to the input signal generated by the touchscreen 110 or the key input unit 120 under the control of the control unit 180. That is, the camera 160 takes a still or motion picture in response to the input signal under the control of the control unit 180. The camera 160 processes the picture to generate digital video data to the control unit 180. The control unit 180 processes the digital data to generate a video signal to the display panel 112. The camera 160 may include a set of lenses for collecting light, a camera sensor for converting the light to electric signal, an image processor for converting analog video signal to digital video signal, and a signal processing device for processing the video signal to display the image on the display panel 112.

The storage unit 170 stores the Operating System (OS) of the mobile terminal, various applications, and data processed in the mobile terminal. The storage unit 170 may include a data region and an application region. The data region of the storage unit 170 stores data generated by the mobile terminal and received from outside and the property information on the data. The data region is also capable of storing screens to be displayed by the display unit 110. The data region is also capable of storing the data copied to be pasted into a data region temporarily. The data region is also capable of storing various settings (e.g., screen brightness) related to the operation of the mobile terminal.

The program region of the storage unit 170 is capable of storing the Operating System (OS) for booting the mobile terminal and application programs for telephony function, video and audio playback function, image display function, and camera function. The program region is also capable of storing the application programs for broadcast playback function, audio recording function, calculator function, organizer function, etc.

In one particular embodiment of the present invention, the storage unit 170 is stores an emergency message template for providing the emergency situation information promptly. The emergency message template may include fields such as time information, location information, emergency detail field, damage information, file attach, and sender information. In one embodiment of the present invention, the storage unit 170 is capable of storing at least one emergency phone numbers (e.g., 911, 112 and 119) for reporting the emergency situation.

The control unit 180 controls overall operations and signal flows among the internal components of the mobile terminal and processes data. The control unit 180 also controls power supply from a battery to the internal components. If the mobile terminal powers on, the control unit 180 controls the boot-up process of the mobile terminal and loads the application programs stored in the program region to execute functions of the mobile terminal.

According to an embodiment of the present invention, the mobile terminal provides an emergency message template for reporting the emergency situation information promptly. One preferred emergency message template may be configured as shown in table 1, where “M” indicates a mandatory field and “O” indicates an optional field.

TABLE 1

| Input fields | | Description |
|---|---|---|
| Recipient (M) | | Emergency call numbers stored in the terminal |
| | | for emergency situation |
| | | Selectable from emergency call menu option |
| | | or input by user |
| Time (M) | | emergency situation occurrence time or |
| | | emergency call placed time |
| | | set to filled with current time (preferably as |
| | | received from an outside network) as default |
| | | this field value can be changed according to |
| | | user request |
| Location (M) | | current location or area where the terminal is |
| | | positioned |
| | | LAC/CID information of GPS-enabled |
| | | terminal and GPS coordinates as default |
| | | automatically |
| | | LAC/CID information received from network |
| | | periodically as default for non-GPS terminal |
| | | this field value can be changed according to |
| | | user request |
| Situation Detail (M) | | detailed information on the emergency |
| | | situation |
| | | information on the emergency situation by |
| | | user |
| Damage | Casualty | casualty number of dead and wounded only to |
| (O) | | request for medical assistance if any casualty |
| | | happened |
| | Dead | |
| | Road/Building | road or building destruction detail to request |
| | | for urgent recovery (e.g., O/X) |

| | |
|---|---|
| Attached file (O) | video or photo |
| | motion or still picture taken by camera or |
| | activate camera to take motion or still picture |
| Sender (M) | device information relating to the specific |
| (auto-input) | device that sent the emergency message to |
| | secure report reliability |
| | phone number of terminal, IMEI, or ESN |
| | locked to make it impossible for user to re- |
| | input or modify |

The control unit 180 preferably generates an emergency message with the template composed of the information fields as listed in table 1. In an embodiment of the present invention, the control unit 180 is capable of including an emergency situation information collector 181 and an emergency message generator 182. If an emergency message display request event is detected, the emergency situation information collector 181 extracts the emergency situation information to be filled into the auto input field of the emergency message template. The emergency situation information collector 181 sends the extracted emergency situation information to the emergency message generator 182. Here, the emergency situation information may include data including, but not limited to the time, location, user identity, and user input information. The time information may be the real time according to the system clock or emergency situation occurrence time (e.g., emergency message display request event occurrence time) that is composed of year, month, day, hour, minute and optionally second. The location information is the information on the location where the emergency situation has occurred (e.g., when emergency message display request event occurrence time). The location information may include at least one of GPS location based on the GPS signal received by the GPS receiver, address information acquired from the GPS location coordinates, and Local Area Code/Cell Identifier (LAC/CID) received from a base station. The user identity information typically denotes the identity information of the mobile terminal used for transmitting the emergency situation information. The user input information is the information input by the user to report the emergency situation detail and may include text, video, photo, and speech recording.

The emergency message generator 182 preferably loads the emergency message template from the storage unit 170 when the emergency message display request event is detected. The emergency message generator 182 controls the terminal such that the emergency message template with the information fields is automatically filled with the emergency situation information collected by the emergency situation information collector 181. Here, the emergency situation information may include, but is not limited to time, location, user identity, and user input information. The time information is filled into the time information filed of the emergency message template, the location information is filled into the location information field, and the user identity information is filled into the user identity information field.

In an embodiment of the present invention, the time and location information fields of the emergency message template are filled with the collected information by the control unit 180 and may be modified, if necessary, by the user. The user identity information field is filled with the information collected by the control unit 180 and preferably cannot be modified by the user. In one embodiment, the time and location information fields are not modifiable by the user.

Although not enumerated herein, the mobile terminal 100 is capable of further including other components equivalent to the aforementioned components selectively according to the tendency of digital device convergence. The mobile terminal 100 according to an embodiment of the present invention is also capable of being implemented with omission of at least one of the aforementioned components or replacement of at least one of the aforementioned component with an equivalent component. According to an embodiment of the present invention, the input unit can be implemented with a touch pad, a track ball, or the like as well as the touch screen 110 and the key input unit 120.

Hereinafter, a description is made of the emergency situation information collection and emergency message transmission procedure according to an embodiment of the present invention.

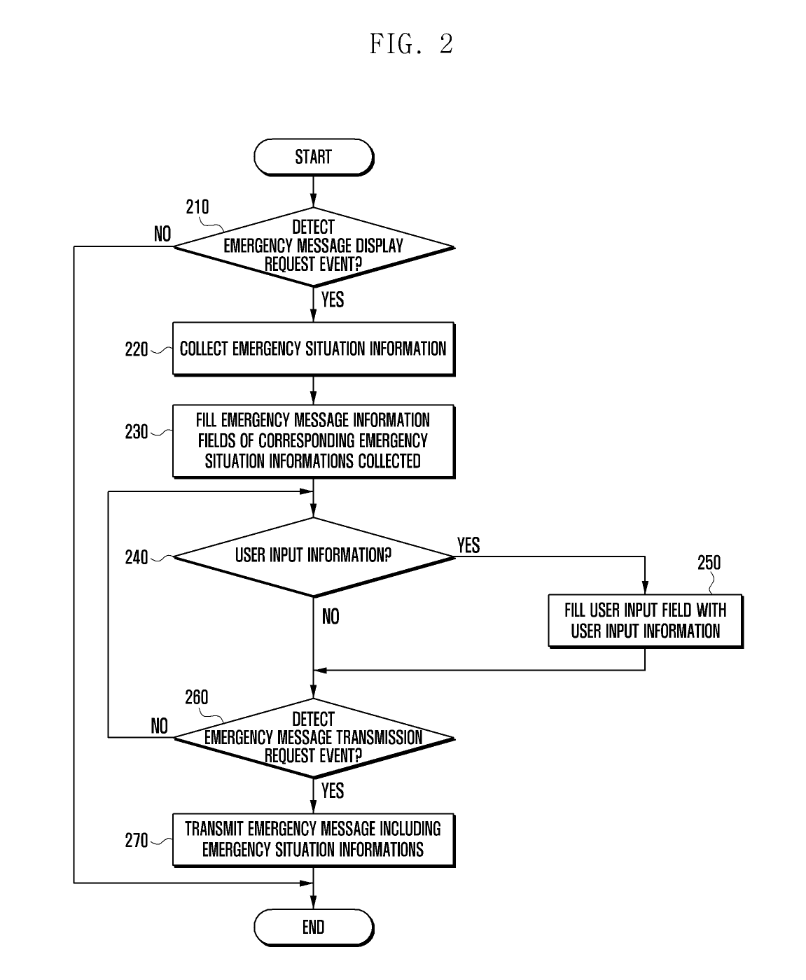

FIG. 2 is a flowchart illustrating the emergency message transmission method of the mobile terminal according to an embodiment of the present invention.

At step 210, the control unit 180 detects an emergency message display request. The emergency message display request event may be detected on one of a texting application execution screen, an emergency communication service screen, a gallery application execution screen, a camera application execution screen. If no emergency message display request event is detected, the procedure ends under the control of the control unit 180.

If the emergency message display request event is detected at step 210, the control unit 180 collects emergency situation information at step 220. The emergency situation information preferably includes time, location, sender, and user input information, as described above. More particularly, the control unit 180 activates the location information collection function, e.g. the GPS receiver, to receive the location coordinates of the terminal. The control unit 180 also acquires the current system time information and identity information of the mobile terminal (e.g., phone number).

The control unit 180 is also capable of collecting user input information (such as text, motion picture, still picture, and voice recording) as a part of the emergency situation information. For example, if a text message is input by means of the texting application and then the emergency message display request vent is detected, the control unit 180 collects the text message as the user input information. Additionally, if a still or motion picture is taken by means of the camera and then the emergency message display request event is detected, the control unit 180 collects the still or motion picture as the user input information. More particularly, once the emergency message display request is received by the control unit 180, recent data input into the terminal, e.g., texts, video and photographs, can be collected and appended to the emergency message information.

The control unit 180 fills the input fields of the emergency message template with the collected emergency situation information. For example, the control unit 180 can load the emergency message template from the storage unit 170 and fills the input fields of the emergency message template with the corresponding emergency situation information. For example, the emergency message template may include recipient, time, location, detailed situation, damage situation, attached file, and sender information fields. The input fields may be classified into mandatory and optional fields (preferably as detailed in Table 1). The mandatory fields may include the recipient, time, location, sender, and detailed situation fields. The optional fields may include the attached file and damage situation fields. The control unit 180 fills the time, location, and sender information fields with the time, location information, and sender information respectively.

At step 240, the control unit 180 determines whether any user input information is detected. If there is no user input information collected yet, the user may fill the emergency detail field with the emergency situation information and attach a file related to the emergency situation. The control unit 180 may check whether the emergency detail field contains any user input (e.g., forest fire at Mt. Jiri) or whether there is any attached file (e.g., video or still picture) in the file attach field. If there is any attached file in the file attach field, the control unit 180 may determine that the terminal is in the state capable of transmitting emergency message although a mandatory emergency detail filed is empty.

At step 260, if no user input information is detected, the control unit 180 determines whether an emergency message transmission request event is detected and, if so, transmits an emergency message including the collected emergency situation information to the recipient (e.g., emergency control center server) at step 270.

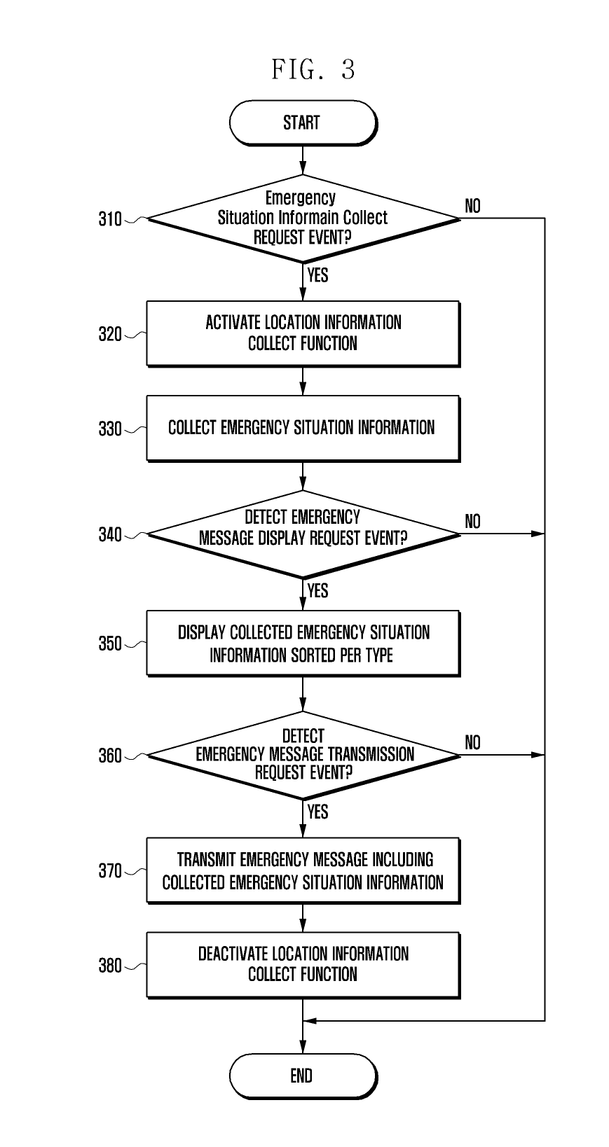

If any user input information is detected, the control unit 180 fills the corresponding input field of the template with the user input information at step 250, determines whether an emergency message transmission request event is detected at step 260, and transmits an emergency message including the collected emergency situation information to the recipient (e.g. emergency control center server) at step 270. If no emergency message transmission request event is detected, returns the procedure to step 240. FIG. 3 is a flowchart illustrating an emergency message transmission method of the mobile terminal according to another embodiment of the present invention.

At step 310, the control unit 180 determines whether an emergency situation information collect request event is detected. The emergency situation information collect request event may be any of an emergency call service execution request event, a text messaging service execution request event, a camera function execution request event, and a gallery function execution request event occurring in the lock screen state. According to an embodiment of the present invention, the control unit 180 detects the situation in which emergency message transmission has to be transmitted to collect emergency situation information. If no emergency situation information collect event is detected, the procedure ends under the control of the control unit 180.

At step 320, the control unit 180 activates the location information collect function in response to the emergency situation information collect request event. In the case of the GPS-enabled mobile terminal, the control unit 180 activates the GPS receiver to check current location of the mobile terminal. In the case of the mobile terminal without GPS function, the control unit 180 performs communication with a nearby network base station to check the current location of the mobile terminal. If no emergency message display request event is detected, the procedure ends under the control of the control unit 180.

Once the location information collect function has been activated, at step 330, the control unit 180 collects emergency situation information. The emergency situation information may include time, location, sender, and user input information. More particularly, once the GPS receiver has been activated, the control unit 180 receives the location coordinates from the GPS receiver or collects the cell identity information from the network base station. The control unit 180 checks the system time and identity information of the mobile terminal (e.g., phone number). If a camera application is executed to take a still and/or motion picture and then an emergency message display request event is detected, the control unit 180 collects the still and/or motion picture as the user input information. More particularly, once an emergency message display request event is detected, the control unit 180 can collect information relating to all videos and photographs recently taken and append such information to the response.

At step 340, the control unit 180 determines whether an emergency message display request event is detected. The emergency message display request event may be input on any of text messaging application execution screen, emergency call service screen, gallery application execution screen, and a camera application execution screen.

At step 350, if the emergency message display request message is detected, the control unit 180 presents the collected emergency situation information sorted by type. For example, the control unit 180 can load the emergency message template from the storage unit 170 and fill the input fields of the template with the corresponding information.

More particularly, the control unit 180 can fills in the time field with the collected time information, the location field with the collected location information, and the sender field with the user identity information. According to an embodiment of the present invention, if there is no user input information collected, the control unit 180 can determine whether there is any user information (as described with reference to steps 240 and 250 of FIG. 2) and, if so, fills the user input information into the corresponding input fields of the template. In the procedure of FIG. 3, steps of determining whether any user input information is detected and, if so, filling the detected user input information into the corresponding fields of the template may be added after the step of displaying the emergency situation information.

At step 360, the control unit 180 can determine whether an emergency message transmission request event is detected. If the emergency message transmission request event is detected, the control unit 180 transmits the emergency message including the emergency situation information to the recipient (e.g., emergency control center server) in response to the emergency message transmission request event at step 370. Finally, the control unit 180 deactivates the location information collection function at step 380 to end the procedure. If no emergency message transmission request event is detected, the procedure ends under the control of the control unit 180.

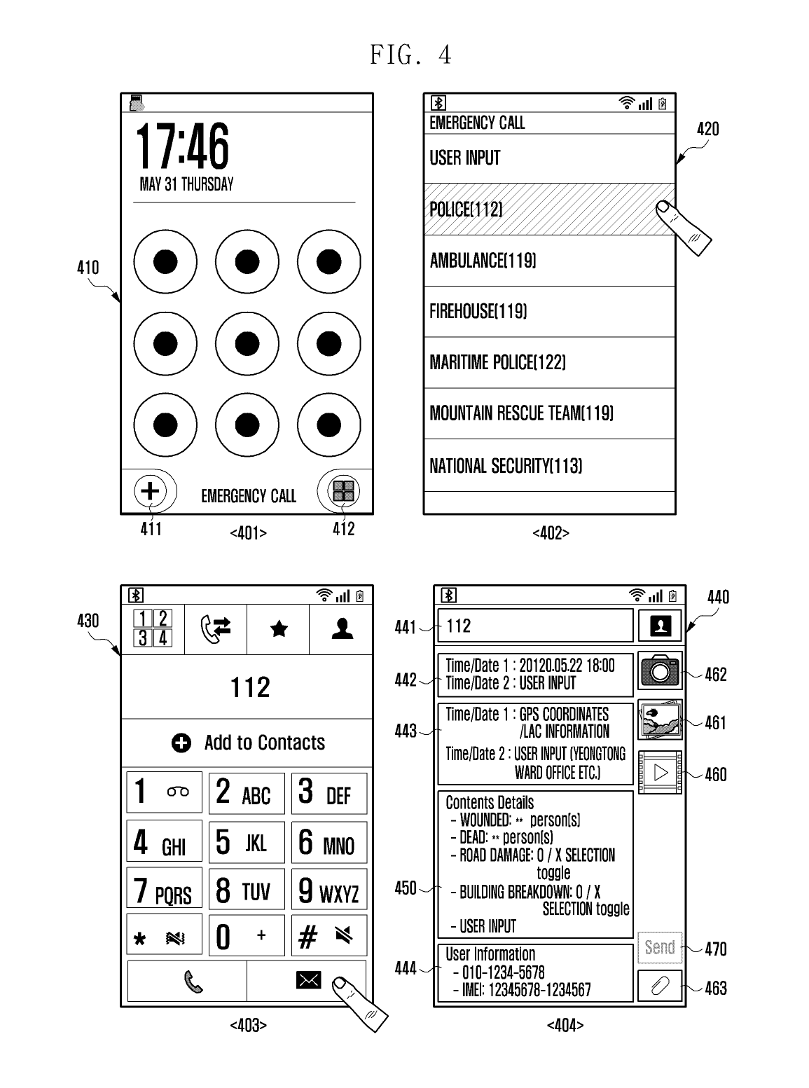

FIG. 4 is a diagram illustrating exemplary screens displayed in association with the emergency message transmission method according to an embodiment of the present invention.

Referring to FIG. 4, the mobile terminal according to an embodiment of the present invention can be provided with an emergency communication service (e.g., emergency call and emergency messaging) in order for the user to request for help in an emergency situation. Reference number 401 denotes an exemplary lock screen according to an embodiment of the present invention. The user may select an emergency call menu button 411 or a keypad menu button 412 on the lock screen 410 without password input. If the emergency call menu button 411 is selected by the user, an emergency call number list 420 is displayed on the exemplary screen as denoted by reference number 402; and if the keypad menu button 412 is selected by the user, a keypad window 430 is displayed as denoted by reference number 403.

The user is capable of selecting an item from an emergency call list 420 in the state of the screen 402 or entering an emergency call number using the keypad window 430 in the state of the screen 403 to place an emergency call. The mobile terminal can be configured such that when the user selects an item from the emergency call list 420 on the screen 402, the call number corresponding to the selected item appears in an input box of the keypad window 430 as shown in the screen 403.

Then the control unit 180 controls the touchscreen 110 to display the keypad window 430 with a call button and a messaging button as shown in the screen 403. The user is capable of attempting to place the emergency call by selecting the emergency call icon or load an emergency message template by selecting an emergency messaging icon. The emergency call icon and emergency messaging icon are shown as examples but not limited thereto in shape and location.

If the user selects the emergency messaging icon in the state of screen 403, the control unit 180 controls the touchscreen 110 to display an emergency message template 440 as shown in the screen 404. In an embodiment of the present invention, the emergency situation information may be collected at the time when the user input for selecting the emergency call menu button 411 is detected in the state of the screen 401 or when the user input for selecting the emergency messaging icon is detected in the state of the screen 403.

The screen 404 shows an exemplary emergency message template 440, but the emergency message template window is not limited thereto. The emergency message template 440 includes a recipient field 441, a time field 442, a location field 443, an emergency detail field 450, a file attach field 463, a sender field 444, and a send key 470, but may include more or fewer fields.

The recipient field 441 is automatically filled with the phone number of the emergency control center selected by the user in the state of screen 402 or manually input by the user in the state of the screen 403. The time filed 442 is automatically filled with the time checked by the control unit 180 and the location field 443 is automatically filled with the GPS coordinates of the mobile terminal or LAC automatically under the control of the control unit. The time and location fields 442 and 443 may be provided with option items allowing the user to re-input or modify the corresponding information. The sender field 444 is automatically filled with the phone number of the mobile terminal and/or IMEI. In an embodiment of the present invention, the sender field 444 may be configured as a field of which value is not capable of being modified by the user.

In an embodiment of the present invention, the recipient field 441, the time field 442, the location field 443, the emergency detail field 450, and the sender field 444 of the emergency message template are the mandatory fields. Although the emergency detail field 450 is a mandatory field requiring user input, it may be skipped for the user to fill the field when there is a file attached.

The control unit 180 controls the touch panel 110 to display the emergency message template having the input fields filled with the corresponding information, i.e., the recipient information, time information, location information, and sender information. In this state, the user is capable of completing the emergency message composition with only simplified input manipulation. Once the emergency message has been completed, the user can select the send key 470 to transmit the message. Then the control unit 180 transmits the emergency message including the emergency situation information to the recipient (i.e., emergency control center server—e.g., phone number 112, as shown in screen 404) in response to the send key 470 input event.

In an embodiment of the present invention, the emergency message template 440 further includes a photo shot button 462, a photo attach button 461, and a video attach button 460. The user is capable of taking and attaching a photo of the emergency situation to the message by manipulating the photo shot button 462 and photo attach button 461 of the emergency message template 440. The user is also capable of accessing a gallery menu in the emergency message template screen to attach a previously stored photo or video footage.

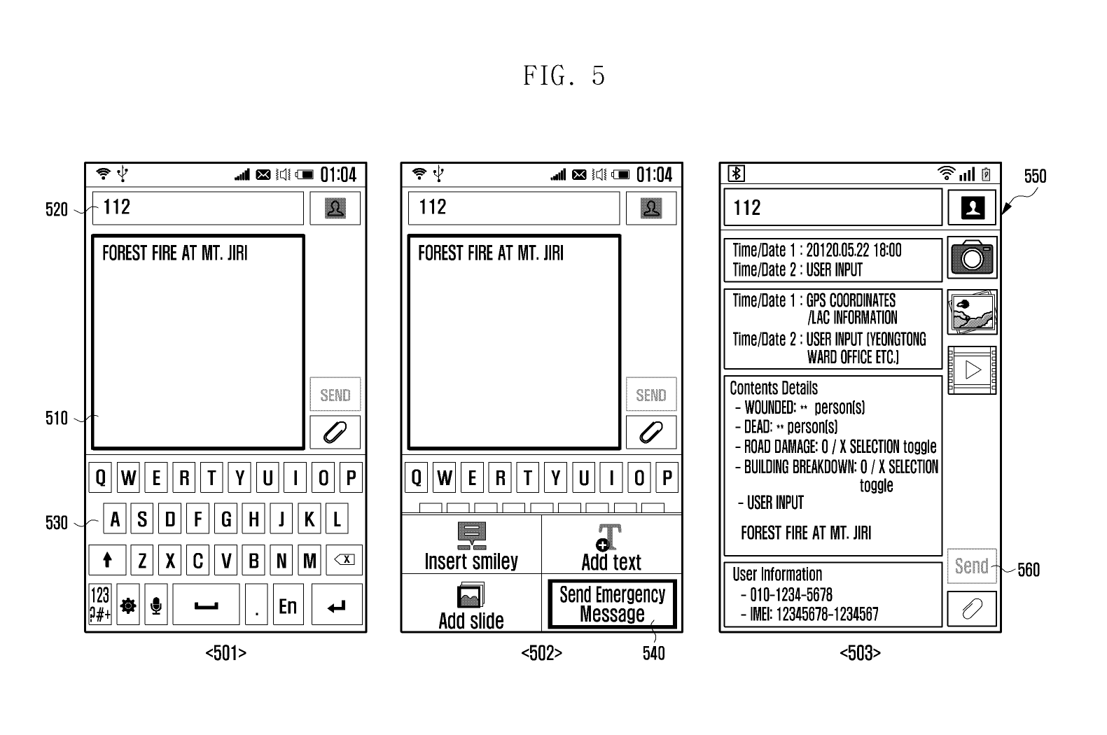

FIG. 5 is a diagram illustrating exemplary screens displayed in association with the emergency message composition procedure of the method according to an embodiment of the present invention.

Referring to FIG. 5, the mobile terminal according to an embodiment of the present invention can be provided with an emergency messaging function which is executed with a message composition screen as denoted by reference number 501. The touchscreen 110 displays the message composition screen 501 in response to a user input. The message composition screen 501 includes a text box 510, a recipient box 520, and a keypad 530. The touch keypad 530 is provided to receive touch-based user input and includes alphabetic keys (e.g., Korean or English vowel and consonant letters) and/or function keys. According to an embodiment of the present invention, the touch keypad 530 may include option keys associated with the emergency message function for writing an emergency message on the message composition screen 501.

The user is capable of entering the phone number of an emergency control center in a recipient box 520 and details of the emergency situation (e.g., forest wire at Mt. Jiri) in the text box and then selecting the option key.

Then the control unit 180 controls such that an emergency message send menu item 540 is presented on the message composition screen as denoted by reference number 502. At this time, the control unit 180 collects the emergency control center phone number entered in the recipient box 520 and the text (e.g. forest fire at Mt. Jiri) entered in the text box 510 as emergency situation information. In one embodiment, irrespective of the number input into the recipient box, the control unit 180 may be configured to scan the text input into text box 510, and should certain predefined keywords be identified, e.g., “fire”, “earthquake” or “emergency”, the emergency message send menu item 540 can be displayed.

If the emergency message display menu is selected by the user, the control unit 180 displays an emergency message template having the information fields filled with the collected emergency situation information on the screen as denoted by reference number 503.

For example, the emergency message template includes the time field filled with the current time, the location field filled with the current location information, and the sender field filled with the sender identifier. An emergency control center number may be input in the recipient field automatically, and the emergency situation detail may be input in the user input field automatically.

Next, the user may select the send key 560. Then the control unit 180 transmits the emergency message including the emergency situation information to the recipient (i.e., emergency control center server or 112) in response to the send key input event. In another embodiment, once the user selects the send emergency message send menu item 540, the message is automatically sent (with the automatically filled fields already populated) without any additional user interaction required. In either case, the most recently sent text messages, photographs and/or videos can be automatically appended to the message as attached files.

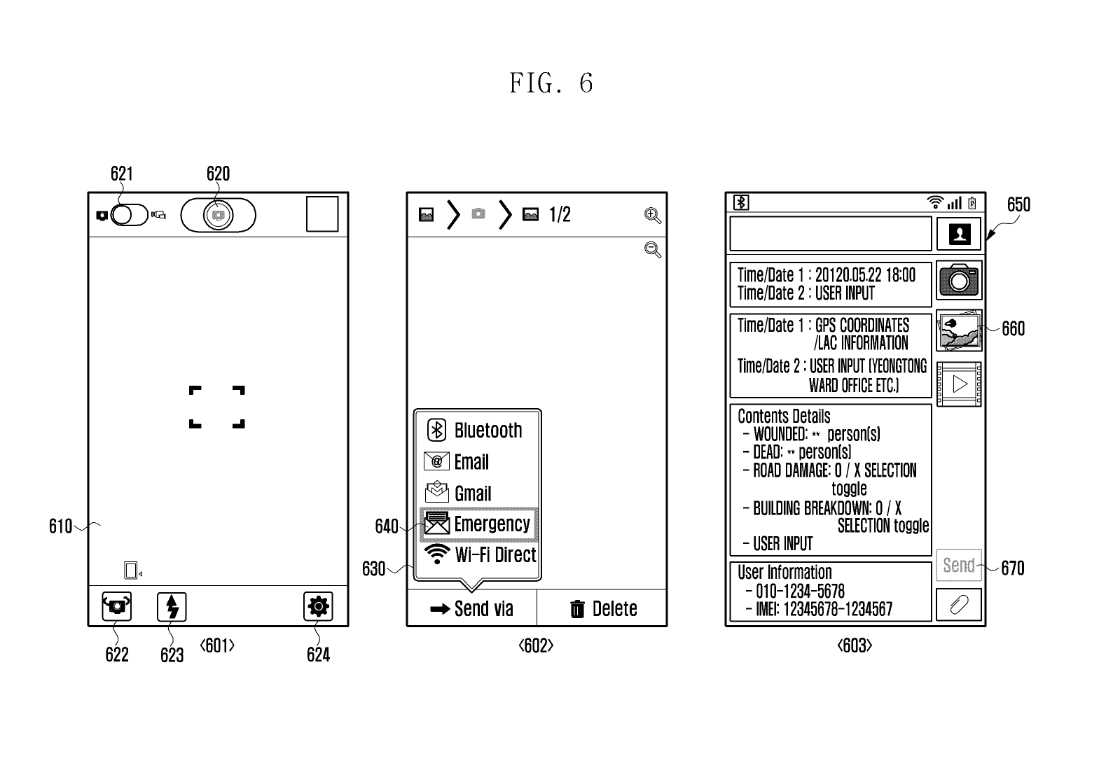

FIG. 6 is a diagram illustrating exemplary screens displayed in association with the execution of the camera in the method according to an embodiment of the present invention.

Referring to FIG. 6, the mobile terminal according to an embodiment of the present invention is provided with an emergency messaging function which is executed with a camera execution screen as denoted by reference number 601. The camera execution screen 601 may include a viewfinder window presenting the camera's preview image and a camera function region. The camera function region may include exemplary buttons such as a shutter button 620, camera-camcorder switch button 621, a front-rear camera switch button 622, a flash button 623, and an option key button 624.

According to an embodiment of the present invention, the camera function region is also capable of including an option key button for attaching a picture captured on the camera execution screen to the emergency message.

The user is capable of shooting a still or motion picture of the emergency situation and then selecting the option key button 624. At this time, the captured still or motion picture can be used as a part of the emergency situation information as an attached file.

The control unit 180 controls the terminal to display the option menu 630, including the emergency message display menu item 640 as in the screen 602. If the user selects the emergency message display menu item 640, the control unit 180 controls the touchscreen 110 to display the emergency message template along with the collected emergency situation information as shown in screen 603. For example, the emergency message template includes the time field filled with the current time, the location field filled with the current location information, and the sender field filled with the sender identifier. In the case that there is a still or motion picture captured in association with the emergency situation, the control unit 180 attaches the picture to the emergency message template automatically.

If the user select a send key 670, the control unit 180 transmits the emergency message including the emergency situation information to the recipient (i.e., emergency control center server or 112) in response to the send key input event. In another embodiment, once the user selects the emergency message display menu item 640, the message is automatically sent (with the automatically filled fields already populated) without any additional user interaction required. In either case, the most recently sent text messages, photographs and/or videos can be automatically appended to the message as attached files.

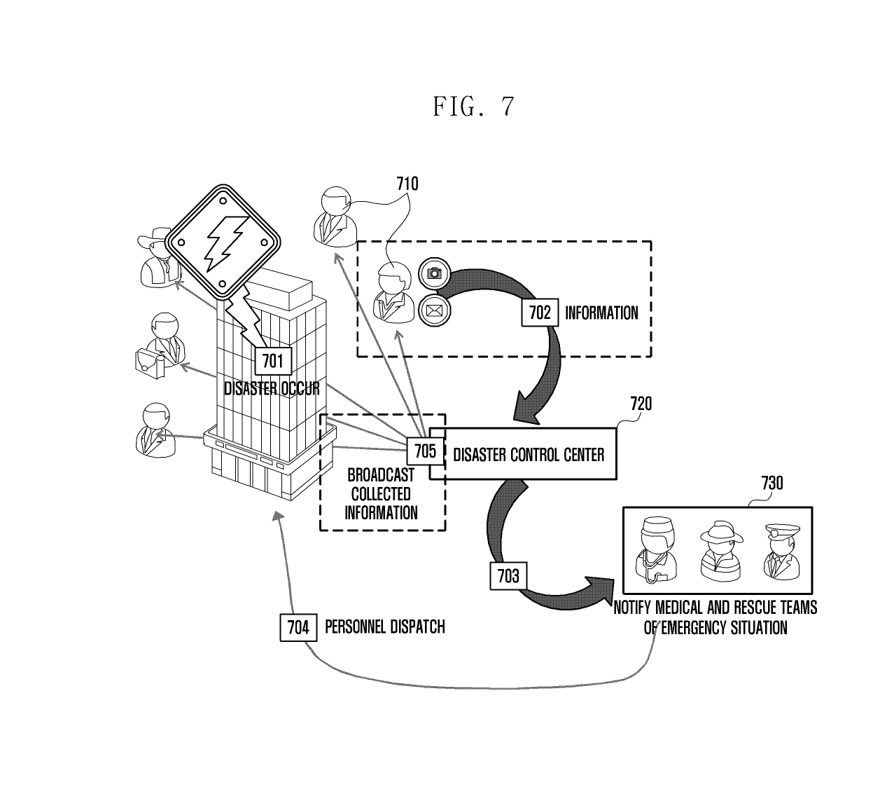

FIG. 7 is a diagram illustrating the architecture of the emergency information processing mechanism for the emergency message transmission method according to an embodiment of the present invention.

At step 701, a plurality of mobile terminal users 710 are aware of an emergency situation. One user 710 calls for the emergency message template to transmit an emergency message to the emergency control center (e.g., recipient server) at step 702. For example, the mobile terminal displays the emergency message template on the touchscreen 110 as shown in screen 404 of FIG. 4 under the control of the control unit 180 according to an embodiment of the present invention. The user 710 completes the emergency detail field with emergency detail and/or attaches an emergency situation picture using the file attach field, and the emergency message is generated as a consequence being transmitted to the emergency control center 720.

The emergency control center 720 then checks the emergency situation based on the emergency situation information carried in the emergency messages transmitted by the mobile terminal user(s) 710. At step, 703, if the emergency situation is checked and confirmed, the emergency control center 720 notifies the users 710 and other related emergency personnel 730 of the emergency situation. The rescue and other related personnel 730 are then dispatched to the location where the emergency situation has occurred (e.g., disaster or accident area) to resolve the emergency situation.

At step 705, the emergency control center 720 collects the information on the follow-up action result and reports the result to the mobile terminal users around the location where the emergency situation has occurred.

A description is made of the procedure of processing at the emergency control center server, the emergency message transmitted by a mobile user hereinafter in detail.

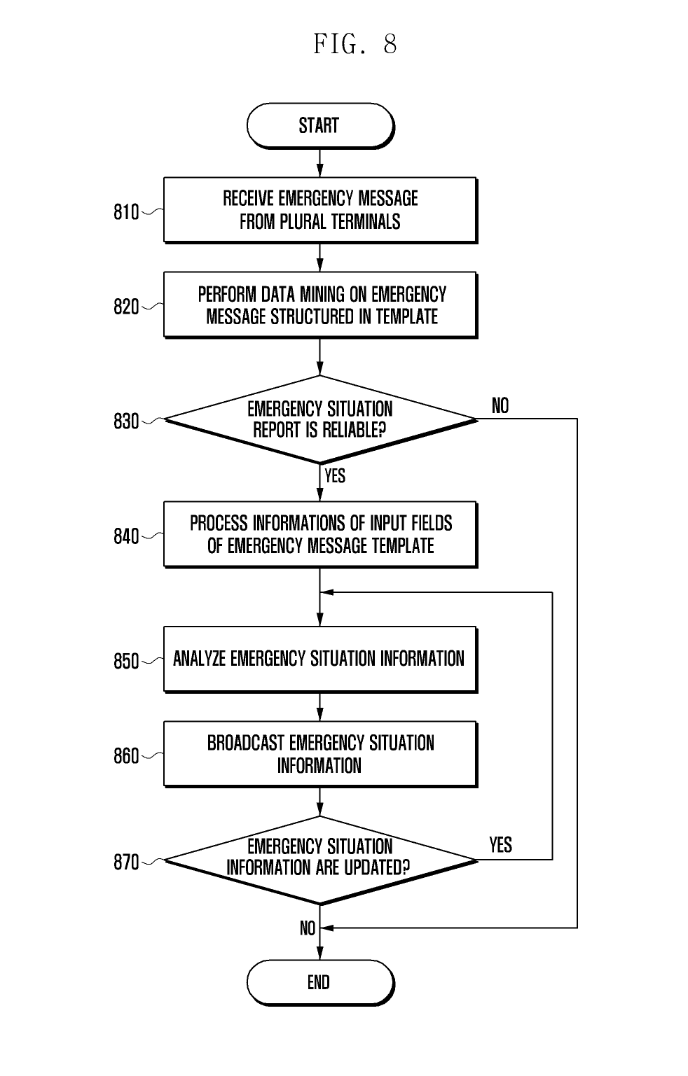

FIG. 8 is a flowchart illustrating the server procedure for receiving the emergency text message and processing the emergency situation in a method according to an embodiment of the present invention.

At step 810, the emergency control center server (e.g., a recipient server and a server maintained by emergency response personnel) receives emergency messages from plural mobile terminals at step 810. At step 820, the emergency control center server checks the reliability of the information received in the form of emergency message templates through data mining process.

At step 803, the emergency control center server determines whether the emergency situation report is reliable and, if so, processes the information of the information fields of the emergency message at step 840. More particularly, the server sorts the data carried in each emergency message as listed in Table 2 and processes the individual data. The reliability can be confirmed in a wide variety of manners, e.g., ensuring that a number of emergency messages are received containing similar data, and requesting a confirmation of the emergency by first responders (e.g., fire and police personnel) in the area. This is only an exemplary process, but the present invention is not limited thereto.

TABLE 2

| Processing type | Information process description |
|---|---|
| Tolerance | check reliability of collected information |
| | apply to only time/location information in receiving |
| | emergency message |
| | tolerable range is set with +− time or radius ** km |
| Time Info. | configure to take statistics and update at interval of 30 |
| | minutes from initial emergency message reception time |
| | if emergency message is valid, configure initial |
| | emergency message receipt time as emergency situation |
| | occurrence time |
| | statistics/update period can be configured by user |
| | (default: 30 minutes) |
| Location Info. | acquire area information using LAC/CID and GPS |
| | coordinates |
| | convert location information included in emergency |
| | message to area name based on pre-configured GP, |
| | LAC/CI mapping table and log the area name |
| Damage Info. | if wounded/dead or building/load destruction is |
| | reported, check where accident has occurred to dispatch |
| | related first responders/department personnel |
| | check only emergency situation occurrence and |
| | dispatch personnel |
| Collected Info. | take statistics of collected information and log time, |
| Report | location, casualty, and other damage periodically |
| | target of emergency situation information report is all |
| | wireless device users within wireless of ** km around |
| | control center/emergency situation occurrence location |
| | cell broadcast emergency situation information at |
| | predetermined period |
| | information provision range (e.g., radius) can be |
| | changed depending on situation |

If the emergency situation report is not reliable, the procedure ends under the control of the control unit 180.

At step 850, the emergency control center server collects and analyzes emergency situation information based on the format of the emergency message template at step 850. For example, the emergency control center server processes the information filled in the respective information fields of the template and ignores the information out of the tolerance ranges of the respective information fields. If it is determined that initial emergency message is correct, the emergency control server to generates an emergency alarm and reviews statistics of the information collected in the tolerable range at a predetermined period from the initial emergency message receipt time.

At step 860, the emergency control center server broadcasts the emergency situation information acquired based on the collected emergency situation data. For example, the emergency control center server may transmit the emergency situation information to all wireless devices within the area of the emergency control center and emergency situation occurrence area through cell broadcasting service. In the case that “wounded/dead” or “building/road destruction” has been reported, the emergency control center server checks the reliability of the report and instructs relevant departments to dispatch personnel to the emergency situation occurrence area.

At step 870, the emergency control center server determines whether the emergency situation is updated. If there is no update of the emergency situation, the emergency control center server ends the procedure and, otherwise if the emergency situation is updated, returns the procedure to step 850. For example, if the emergency messages are received at 10:30, 10:40 and 10:52, the emergency control center server generates the emergency alarm immediately upon receipt of the emergency message at 10:30. Next, the emergency control center server updates the emergency situation information at an interval of 30 minutes and broadcasts the emergency situation information within the area where the emergency situation has occurred.

As described above, the emergency message transmission apparatus and method of the mobile terminal according to the present invention is capable of collecting emergency situation information and reporting the collected information to the emergency control center promptly. In order to accomplish this, the mobile terminal has an emergency message template which is displayed along with pre-collected emergency situation—related information in response to an emergency message transmission request so as to minimize the laborious user input, thereby reporting the emergency situation to the emergency control center promptly.

Also, the emergency message transmission apparatus and method of the mobile terminal according to the present invention is preferably capable of allowing the emergency control server to checks the reliability of the emergency situation reports based on the consistently formatted emergency messages so as to resolve the emergency situation promptly. More particularly, the mobile terminal of the present invention can collect emergency situation information through bidirectional communication with the emergency control center (e.g., emergency management department) so as to handle the emergency situation quickly. The emergency message transmission method and apparatus of the present invention preferably is capable of checking the reliable emergency situation information provided by the users in the formalized emergency message template and broadcasting the emergency situation to the wireless device users within the emergency situation area quickly. Also, the emergency message transmission method and apparatus of the present invention is preferably capable of checking the personnel required for handling the emergency situation and dispatching the emergency task force and related personnel immediately, thereby minimizing the damage caused by the emergency situation.

The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101 and none of the elements consist of software per se.

The specification and drawings are to be regarded in an illustrative rather than a restrictive sense in order to help understand the present invention. It is obvious to those skilled in the art that various modifications and changes can be made thereto without departing from the broader spirit and scope of the invention.

What is claimed is:

1. A method for transmitting an emergency message from a terminal, the method comprising:
detecting an emergency situation information collect request event by an input unit;
collecting emergency situation information in response to the emergency situation information collection request event in a memory;
detecting by a control unit an emergency message display request event by the input unit;
displaying collected emergency situation information on a display sorted by type in response to the emergency message display request event;
detecting by the control unit an emergency message transmission request event by an input unit; and
transmitting an emergency message by a wireless communication unit including the emergency situation information to at least one recipient number in response to the emergency message transmission request event.

2. The method of claim 1, wherein the emergency situation information collect request event is at least one of an emergency call serving execution request event, a text messaging service execution request event, a camera function execution request event, and a gallery function execution request event.

3. The method of claim 1, wherein the collecting comprises:
activating by the control unit a Global Positioning System (GPS) receiver in response to the emergency situation information collect request event;
receiving GPS location coordinates from the GPS receiver; and
processing the GPS location coordinates to generate emergency situation information.

4. The method of claim 1, wherein the emergency situation information comprises a time of the terminal, a location of the terminal, a sender, and a user input information.

5. The method of claim 4, wherein the user input information comprises at least one of a text, a video file, a photo file, and of voice file.

6. The method of claim 1, wherein the emergency message display request event is detected by the control unit in one of an emergency call mode, a camera execution mode, a message composition mode, a photo gallery execution mode, and a voice recording mode.

7. The method of claim 1, wherein displaying comprises:
loading an emergency message template stored in the storage unit; and
displaying the emergency message template having information fields filled with the corresponding emergency situation information respectively.

8. The method of claim 7, wherein the information fields comprises mandatory fields and optional fields: the mandatory fields comprising at least one selected from the group of a recipient field, a time field, a location field, a sender field, and an emergency detail field; and the optional fields comprising at least one selected from the group of an emergency detail field, a file attach field, and a damage situation field.

9. The method of claim 3, wherein the emergency detail field is filled with at least one of text and attached video, photo, and voice files.

10. The method of claim 7, further comprising:
determining by the control unit whether any text is input, after displaying the emergency message template; and
presenting, when any text is input, the input text in a corresponding input field of the template.

11. The method of claim 1, wherein collecting comprises retrieving at least one of still and motion pictures captured in a camera execution mode or receiving a text input in a text composition mode.

12. The method of claim 1, wherein the collecting comprises assembling automatically generated emergency situation information.

13. The method of claim 12, wherein the automatically generated emergency situation information comprises at least one of device information, phone number of the terminal and a physical location of the terminal.

14. The method of claim 12, wherein the displaying comprises displaying the automatically generated emergency situation information and permitting changes to the emergency situation information prior to transmitting.

15. A terminal comprising:
a touchscreen configured to detect a user's request event related to emergency message and display the emergency message with collected emergency situation information;
a storage unit configured to store a template of the emergency message;
a wireless communication unit configured to transmits the emergency message; and
a control unit configured to control collecting emergency situation information corresponding to input fields of the template, displaying collected emergency situation information sorted by type, and transmitting an emergency message including the emergency situation information in response to the emergency message transmission request event.

16. The terminal of claim 15, wherein the control unit is configured to control collecting the emergency situation information when the emergency situation information collect request event is detected.

17. The terminal of claim 15, wherein the emergency situation information comprises at least one of a time of the terminal, a location of the terminal, a sender, and a user input information.

18. The terminal of claim 15, further comprising a Global Positioning System (GPS) receiver configured to acquire location information of the terminal, wherein the control unit is configured to control the GPS receiver for collecting the emergency situation information and deactivating the GPS receiver when emergency message is transmitted completely.

19. The terminal of claim 15, wherein the information fields comprises mandatory fields and optional fields, wherein the mandatory fields comprise at least one of a recipient field, a time field, a location field, a sender field, and an emergency detail field; and the optional fields comprise at least one of an emergency detail field, a file attach field, and a damage situation field, wherein the emergency detail field is filled with at least one of text and attached video, photo, and voice files.

20. The terminal of claim 15, wherein the control unit is configured to determine whether any text is input, after displaying the emergency message template and controls presenting, when any text is input, the input text in a corresponding input field of the template.
